(19) United States
(12) Patent Application Publication
(10) Pub. No.: US 2007/0209400 A1
(43) Pub. Date: Sep. 13, 2007

(54) Method For Producing An Optical Component

(75) Inventors: Achim Hofmann, Frankfurt am Main (DE); Clemens Schmitt, Blankenbach (DE); Jan Vydra, Hanau (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: HERAEUS TENEVO GMBH, HANAU (DE)

(21) Appl. No.: 10/593,508

(22) PCT Filed: Mar. 16, 2005
(86) PCT No.: PCT/EP05/02784

§ 371 Date: Sep. 20, 2006

(30) Foreign Application Priority Data
Mar. 22, 2004 (DE) 10 2004 014 345.5

(51) Int. Cl. C03B 37/012

(52) U.S. Cl. 65/435

(57) ABSTRACT

According to a previously known method for producing an optical component from synthetic quartz glass, a coaxial arrangement comprising an outer jacket tube, an inner jacket tube that is provided with an internal bore, and a core rod whose bottom face rests on a thrust bearing within the internal bore, is fed into a heating zone in a vertical orientation, is softened therein zone by zone, and is elongated so as to obtain the quartz glass component. In order to create a simple and inexpensive method that is based on said method and makes it possible to reproducibly manufacture a high-quality optical component, the thrust bearing is embodied as a constriction of the internal bore of the inner jacket tube.

The present invention relates to a method for producing an optical component from synthetic quartz glass in that a coaxial arrangement comprising an outer jacket tube, an inner jacket tube provided with an internal bore, and a core rod having a lower face end resting on an abutment within the internal bore is fed in vertical orientation to a heating zone, is softened therein zonewise and elongated to obtain the quartz glass component.

Optical components in the form of intermediate products (preforms or single solid cylinders) for an optical fiber, or also directly the optical fiber, are produced by collapsing and elongating a coaxial arrangement consisting of core rod and a plurality of jacket tubes overcladding the core rod. All variants of the method lay special emphasis on a coaxial guidance and fixation of core rod and jacket tubes relative to one another that is as exact as possible.

U.S. Pat. No. 6,460,378 B1 discloses a method of the above-mentioned type in which a core rod is simultaneously overclad with an inner jacket tube and an outer jacket tube in a vertical arrangement in an elongation process. For the fixation of the core rod the outer jacket tube is provided in the area of its lower end with a constricted portion. The constricted portion serves as an abutment for a holding ring which in the vertically oriented state of the outer jacket tube is introduced from above into the internal bore of the jacket tube. The holding ring has an outer diameter smaller than the inner diameter of the outer jacket tube, but slightly larger than the inner diameter of the constricted portion, so that the holding ring comes to rest from above on the constricted portion. The conically shaped lower end of the core rod extends through the central bore, thereby forming a stop for the core rod. Moreover, the first inner jacket tube rests at the front side on the holding ring.

In this method a constricted portion must be produced for fixing the components (core rod and two jacket tubes) relative to one another. The formation of the constricted portion requires a particularly complicated hot deformation step especially in the case of the outer jacket tube that has a particularly large cross-section as a rule and thus a large mass to be heated. Moreover, a lost quartz glass element which is adapted to this constricted portion and shaped in the form of the holding ring is required. The type suggested for mounting the individual components relative to one another requires a horizontal orientation of said holding ring that is as exact as possible, which is however rendered difficult by the fact that the constricted portion is produced by glass blowing techniques exhibiting the known limitations with respect to dimensional stability.

The components which are fixed relative to one another by means of the holding ring are then fused to each other at their upper ends, a vacuum being generated and maintained in the internal bore of the outer jacket tube. To this end a sealing ring is needed for sealing the gap between the inner and outer jacket tube, the sealing ring also helping to fix the components relative to one another in the upper region of the arrangement. An additional heating process step is needed for fusing the upper ends; it is here hardly possible to correct ensuing deviations from the desired geometry at a later time.

The reproducible production of an optical high-quality component requires considerable efforts with respect to manufacture and time in this procedure for ensuring an exact coaxial arrangement and fixation of core rod and jacket tubes relative to one another prior to the elongation process.

It is therefore the object of the present invention to provide a simple and inexpensive method for producing high-quality optical components by elongation of a coaxial arrangement of core rod and a plurality of jacket tubes.

Starting from the above-mentioned method, this object is achieved according to the invention in that the abutment is configured as a constriction of the internal bore of the inner jacket tube.

In contrast to the known method, neither a holding ring nor a constricted portion of the inner diameter in the outer jacket tube is needed for fixing the core rod.

A holding ring can be dispensed with, so that no manufacturing efforts are required for making the holding ring, nor do any of the above-explained problems arise that are entailed by a horizontal orientation of the holding ring and the fixation of core rod and inner jacket tube.

As a rule, the inner jacket tube has a mass less than that of the outer jacket tube. The configuration of a constricted portion of the inner diameter in the inner jacket tube is thus less troublesome, and the formation of a predetermined geometry is made easier under technical aspects.

Hence, the method according to the invention requires comparatively small efforts for a reproducible manufacture of dimensionally stable optical components (rod, preform, fiber).

The outer jacket tube may consist of one or several tubes. This has no substantial impact on the light guidance of the optical component. Therefore, the demands made on the optical properties of the quartz glass for the outer jacket tube are comparatively small. The quartz glass needed for this can therefore be produced at very low costs in comparison with the quartz glass used for the inner jacket tube. That is why the expensive inner jacket tube is made as thin as possible, but as thick as necessary. Typically, the inner jacket tube has a wall thickness in the range of 5 mm to 20 mm. In the optical component, the volume fraction of the quartz glass deriving from the outer jacket tube is 80% or more.

Due to the constriction, the internal bore of the inner jacket tube is closed fully or in part. In the last-mentioned alternative, the constriction is provided with an axially continuous opening which permits a gas purging of the internal bore until complete collapsing of the internal bore during elongation. This variant of the method is therefore preferred.

It has turned out to be useful when the core rod has a core region with an outer diameter “d_{K}” that is surrounded by a cladding glass layer having an outer diameter “d_{M}”, the ratio of “d_{M}” to “d_{K}” ranging from 2 to 4, preferably from 2.5 to 3.5.

The volume fraction of the innermost cladding glass layer that is near the core and thus particularly complicated to produce is kept as small as possible for reasons of costs in favor of the remaining jacket material that can be produced much cheaper and derives, for instance, from the inner jacket tube.

Advantageously, the core rod is formed from butt-jointed core rod pieces.

For this purpose, small-sized core rods which can be produced more easily or at lower costs might be used for making the core rod, or also selected residual pieces.

The core rod pieces may be fused to one another or also loosely stacked one on top of the other. The last-mentioned procedure is preferred because the core rod pieces permit a smaller safety gap between jacket tube and core rod on the one hand and can moreover be centered automatically due to a radial movability inside the internal bore of the inner jacket tube in the elongation process, on condition that the end faces are displaceable relative to one another, i.e. they are e.g. made planar.

In this connection it has turned out to be useful when a mechanical stop is provided that prevents an upward movement of the core rod in a direction opposite to the drawing direction in the elongation process.

The stop prevents a “floating” of the core rod in the elongation process. This has a particularly advantageous effect when a number of core rod pieces are used. The stop is e.g. formed by means of a holding pin which projects through the wall of the inner jacket tube into the internal bore thereof and can be drawn off.

It has turned out to be advantageous when an inner annular gap with a mean gap width in the range between 0.5 mm and 1.5 mm is provided between the core rod and the inner jacket tube.

A small gap width facilitates the elongation process and ensures a high dimensional stability (in particular, small ovality) and an insignificant eccentricity of the core in the optical component.

In this respect it has also turned out to be useful when an outer annular gap with a mean gap width of not more than 2 mm, preferably of not more than 1 mm, is provided between the inner jacket tube and the outer jacket tube.

In a particularly preferred configuration of the method according to the invention, the inner jacket tube is kept movable in lateral direction.

A self-centering operation is accomplished during elongation due to the fact that the inner jacket tube can freely move in a direction transverse to the drawing direction. The lateral movability follows from the kind of mounting of the upper end of the jacket tube, which for instance permits a displacement in a direction transverse to the drawing direction or an oscillating movement in the sense of a gimbal mounting.

It has turned out to be advantageous when a holding cylinder of quartz glass is fused onto the upper end of the outer jacket tube.

The holding cylinder consists of low-quality quartz glass and forms part of the holding means for the outer jacket tube. This replaces expensive quartz glass and reduces losses in material in this respect. In the simplest case it is a hollow cylinder with the same or similar lateral dimensions as the outer jacket tube.

A configuration of the holding cylinder in which a circumferential groove is provided for the engagement of a gripper turns out to be particularly suited for the purpose of mounting the outer jacket tube.

In a first preferred embodiment of the method of the invention, a first holding means engages the upper end of the outer jacket tube and a second holding means engages the upper end of the inner jacket tube, the first holding means and the second holding means being mechanically independent of one another.

In this configuration, the inner jacket tube together with the core rod arranged therein and the outer jacket tube can be moved in the drawing direction and in a direction transverse thereto independently of each other. These additional parameter settings in the elongation process facilitate the observance of the predetermined geometry of the optical component.

In a further and equally preferred embodiment of the method of the invention, a first holding means engages the upper end of the outer jacket tube, the upper end of the inner jacket tube being held on the outer jacket tube or on the first holding means.

In this configuration the outer jacket tube simultaneously serves to guide and fix the inner jacket tube together with the core rod arranged therein. A separate holding means for guiding and fixing the inner jacket tube and the core rod is thereby avoided.

In this context a variant of the method turns out to be particularly simple where the upper end of the inner jacket tube or a mechanical extension of the inner jacket tube is provided with an outer collar which rests on the outer jacket tube or on a mechanical extension thereof.

The outer collar is e.g. configured as an outwardly projecting bead or as an outwardly protruding expansion of the upper end of the inner jacket tube, and it must here be ensured that the outer collar extends to such an extent that it rests on the upper side of the outer jacket tube or on an extension thereof (e.g. by means of the above-described holding cylinder).

Advantageously, the inner jacket tube has a mean hydroxyl group content of less than 1 wt ppm.

The lower the mean OH content of the inner jacket tube, particularly in the area of its internal bore, the smaller is the attenuation fraction created by hydroxyl groups (OH groups) in the optical component.

A further improvement is accomplished when the inner jacket tube is produced by elongating a hollow cylinder that has been mechanically treated to a final dimension.

Thanks to the mechanical treatment, which particularly includes drilling, grinding and honing, a thick-walled quartz glass cylinder with exactly defined dimensions can first be produced by using known grinding and honing methods and commercial apparatus suited therefor. On account of the subsequent elongation process a quartz-glass jacket tube is produced from the thick-walled cylinder, the jacket tube having a length several times the length of the cylinder and, in particular, an internal bore that is particularly smooth and produced in the melt. During melting with the core rod said smooth inner surface yields a particularly low-defect contact surface, which has an advantageous impact on the quality of the optical component.

To ensure exact dimensions, preference is given to a procedure in which the outer jacket tube is present as a hollow cylinder that has been mechanically treated to a final dimension.

A jacket tube mechanically treated to a final dimension within the meaning of this invention is also a jacket tube whose inner surface has been treated mechanically to a final dimension and which is subsequently purified by etching. Uniform etching processes do not bring about any essential change in the geometrical final shape of the hollow cylinder (for instance a bend or ovality in the cross-section).

Advantageously, the outer jacket tube is formed with a downwardly tapering lower end.

The start of the elongation process (pulling) is facilitated by a shape of the lower end of the outer jacket tube that resembles a drawing bulb.

The method according to the invention shall now be explained in more detail with reference to embodiments and a drawing. The drawing is a schematic illustration showing in detail in

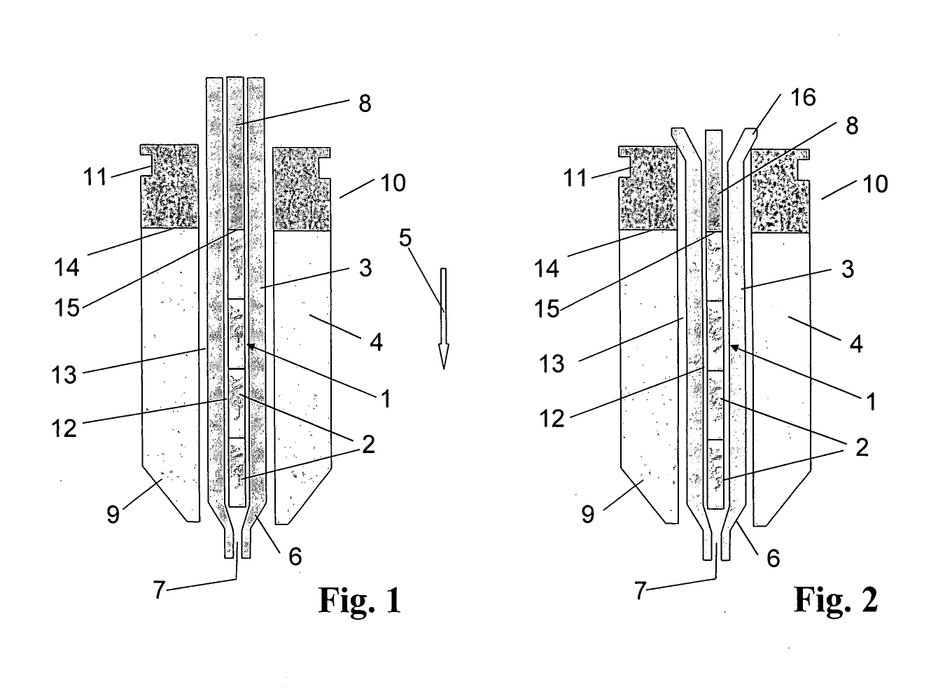

FIG. 1 a first embodiment of an arrangement consisting of core rod, inner jacket tube and outer jacket tube prior to the elongation process;

FIG. 2 a second embodiment of said arrangement.

The arrangement according to FIG. 1 shows a core rod 1 which consists of a plurality of pieces 2 of high-purity synthetic quartz glass having a mean hydroxyl group content of less than 1 wt ppm, the pieces being loosely stacked one upon the other in the internal bore of an inner jacket tube 3.

The end faces of the core rod pieces 2 are made planar, so that they can slide to some extent in lateral direction inside the internal bore of the inner jacket tube 3, thereby contributing to a self-centering in the elongation process. Each of the core rod pieces 2 consists of a core region of germanium-doped quartz glass with an outer diameter “d_{K}” of 11 mm, the core region being surrounded by an inner jacket region of undoped quartz glass with an outer diameter “d_{M}” of 28 mm. Thus the ratio of “d_{M}” to “d_{K}” is 2.55.

The inner jacket tube 3 having an inner diameter of 30.0 mm and an outer diameter of 50 mm is surrounded by an outer jacket tube 4 having an inner diameter and an outer diameter of 52 mm and 150 mm, respectively.

Hence, there remains an annular gap 12 between the inner jacket tube 3 and the core rod 1 with a gap width that is 1 mm on average, and an annular gap 13 with a mean gap width of 1 mm between the outer jacket tube 4 and the inner jacket tube 3.

The inner jacket tube 3 consists of synthetically produced quartz glass of high purity with a mean hydroxyl group content of 0.3 wt ppm. The jacket tube 3 is produced by stretching a hollow cylinder which has been mechanically treated to a final dimension, and it therefore has a particularly smooth internal bore produced in the melt, which shows a mean roughness depth (Rₐ value) of about 0.2 μm.

The lower end of the inner jacket tube 3 has a downwardly conically tapering region which forms a constriction 6 of the internal bore of the inner jacket tube 3. The constriction 6 of the internal bore is such that a continuous opening 7 with an opening width of 10 mm remains relative to the internal bore.

The lower end of the core rod 1 is seated on said constriction 6. The upper side of the core rod 1 is formed by a fixing rod 8 which is prevented from “floating” in the elongation process, which will be described in more detail further below, by means of a pin which is put through the wall of the inner jacket tube 3 and extends up to and into the internal bore.

The outer jacket tube 4 is mechanically treated to a final dimension and it also consists of synthetically produced quartz glass. The lower end 9 of the outer jacket tube 4 extends conically downwards, which facilitates pulling in the elongation process.

The outer jacket tube 4 is extended upwards by means of a fused holding cylinder 10, which consists of low-quality quartz glass. The holding cylinder 10 is provided with a surrounding rectangular groove 11 which serves as a receiver for a first gripper (not shown in the figure), by means of which the outer jacket tube 4 is held and moved.

The joint 14 of holding cylinder 10 and outer jacket tube 4 and the contact point between fixing rod 8 and the uppermost core rod piece 2 are positioned at the same level.

The inner jacket tube 3 together with the core rod 1 fixed therein is gripped and guided by means of a second gripper (not shown in the figure), and it is moveable by said gripper independently of the outer jacket tube 4. To be more specific, the gripper for mounting the inner jacket tube 3 is gimbaled, so that the inner jacket tube 3 is pivotable about the gimbal mounting in a direction transverse to the drawing direction (directional arrow 5), which contributes to a self-centering during the elongation process.

Insofar as FIG. 2 uses the same reference numerals as FIG. 1, these will designate constructionally identical or equivalent components and parts as have been explained in more detail above with reference to the description of the first embodiment of the arrangement.

In contrast to the arrangement of FIG. 1, the inner jacket tube 3 is not held and guided in the arrangement of FIG. 2 by means of a separate gripper, but by means of the outer jacket tube 4. To this end the upper end of the inner jacket tube 3 is provided with an outwardly oriented collar 16 which rests on the upper side of the holding cylinder 10.

A procedure that is typical of the method of the invention shall now be explained in more detail in the following with reference to FIG. 1.

The core rod pieces 2 are first of all produced according to the VAD method. To this end a soot body is produced on a rotating support by axial deposition of a central GeO₂-doped core layer and an undoped SiO₂ layer surrounding the same, the soot body being subsequently subjected to a dehydration treatment in a chlorine-containing atmosphere and vitrified in a vitrification furnace at a temperature in the range around 1350° C., so that a core rod is obtained with an outer diameter of 28 mm and the desired refractive index profile.

The weight of an individual core rod piece depends on its length, which may vary considerably. In the optical fiber to be produced, which has an outer diameter of 125 μm, the core rod pieces 2 form a core region having a diameter of about 8.5 μm.

As an alternative to the above-described production method of the core rods according to the VAD method, these may also be produced according to the known MCVD, OVD, PCVD or FCVD (furnace chemical vapor deposition) method.

In each case further jacket material is provided for forming the outer cladding glass layer in the form of the jacket tubes 3 and 4 which are collapsed onto the core rod 1 during fiber drawing. The jacket tube 3, 4 is produced with the help of a standard OVD method without addition of a dopant.

The outer wall of the obtained quartz glass tubes is ground off to the desired outer dimension by means of circumferential infeed grinding or longitudinal grinding in several operations using successively finer grain sizes. Likewise, the internal bore is drilled by means of a drill and reworked by honing for the purpose of a high-precision finishing operation with respect to shape and surface condition. This yields a straight bore extending in the longitudinal axis direction and having an exactly circular cross-section. To reduce surface tensions and to remove damage caused by the surface treatment, the respective quartz glass tube is etched for a short period of time in a hydrofluoric acid bath having an HF concentration between 5% and 30%.

The resulting quartz glass tube is elongated to a length twelve times its initial length, so that an inner jacket tube 3 is obtained with the above-indicated dimensions. The lower end of the inner jacket tube 3 is then softened with formation of the taper 6.

The outer jacket tube 4 is produced in a similar way, the elongation step and the formation of a taper being here omitted. The conical region 9 of the outer jacket tube 4 is produced by mechanical treatment. The holding cylinder 10 which is provided with the circumferential groove 11 is fused onto the upper end of the outer jacket tube 4.

The internal bore of the inner jacket tube 3 is filled with core rod pieces 2 and the fixing rod 8, the introduction of the core rod pieces 2 being facilitated because of the short lengths of said pieces. The inner jacket tube 3 is then connected to a gripper that engages the upper end of the jacket tube 3 and is inserted into the outer jacket tube 4. The outer jacket tube 4 is also gripped by a further gripper that engages into the circumferential groove 11.

Said coaxial arrangement of core rod 1, inner jacket tube 3 and outer jacket tube 4 is then softened zone by zone in vertical orientation, starting with the lower end, in an annular furnace to a temperature around 2050° C. and an optical fiber is drawn off from the softened region in this process. As long as the lower end of the arrangement has not been softened and collapsed yet, a purging gas stream of nitrogen is passed through the gap 12 and the gap 13 and through the internal bore and the opening 7 for preventing the penetration of impurities.

At the beginning of this drawing method, the core rod pieces 2 rest on the constriction 6 of the inner jacket tube 3. The core rod pieces 2 and also the inner jacket tube 3 and the outer jacket tube 4 are movable independently of one another other in a direction transverse to the drawing direction 5, which contributes to a self-centering of the arrangement during the elongation process.

An optical fiber having an outer diameter of 125 μm is drawn off from the softened and collapsed region of the arrangement. A preform for an optical fiber is produced in a similar way.

1. A method for producing an optical component from synthetic quartz glass, said method comprising: feeding a coaxial arrangement comprising an outer jacket tube, an inner jacket tube provided with an internal bore, and a core rod having a lower face end resting on an abutment within the internal bore in vertical orientation to a heating zone, softening said coaxial arrangement therein zonewise and elongating said coaxial arrangement to obtain the optical component, wherein the abutment is configured as a constriction of the internal bore of the inner jacket tube.

2. The method according to claim 1, wherein the constriction is provided with an axially continuous opening.

3. The method according to claim 1, wherein the core rod comprises a core region having an outer diameter surrounded by a cladding glass layer having an outer diameter wherein a ratio of the outer diameter of the cladding glass layer to the outer diameter of the core region ranges from 2to 4.

4. The method according to claim 1, wherein the core rod is formed from butt-jointed core rod pieces.

5. The method according to claim 4, wherein the core rod pieces are loosely stacked one upon the other.

6. The method according to claim 1, wherein a mechanical stop is provided which prevents an upward movement of the core rod in a direction opposite to a pulling direction.

7. The method according to claim 1, wherein the core rod and the inner jack tube define therebetween an inner annular gap with a mean gap width in a range between 0.5 mm and 1.5 mm.

8. The method according to claim 1, wherein the inner jack tube and the outer jacket tube define therebetween an outer annular gap with a mean gap width of not more than 2 mm.

9. The method according claim 1, wherein the inner jacket tube is movably held in a lateral direction.

10. The method according to claim 1, wherein a holding cylinder of quartz glass is fused onto an upper end of the outer jacket tube.

11. The method according to claim 10, wherein the holding cylinder has a circumferential groove in which a gripper engages the holding cylinder.

12. The method according to claim 1, wherein a first holding means engages an upper end of the outer jacket tube, and a second holding means engages an upper end of the inner jacket tube, the first holding means and the second holding means being mechanically independent of each other.

13. The method according to any one of claim 1, wherein a first holding means engages an upper end of the outer jacket tube, and that an upper end of the inner jacket tube is held on the outer jacket tube or on the first holding means.

14. The method according to claim 13, wherein the upper end of the inner jacket tube or a mechanical extension of the inner jacket tube is provided with an outer collar which rests on the outer jacket tube or on a mechanical extension thereof.

15. The method according to claim 1, wherein the inner jacket tube has a mean hydroxyl group content of less than 1 wt ppm.

16. The method according to claim 1, wherein the inner jacket tube is produced by elongating a hollow cylinder which has been mechanically treated to a final dimension.

17. The method according to claim 1, wherein the outer jacket tube comprises a hollow cylinder which has been mechanically treated to a final dimension.

18. The method according to claim 1, wherein the outer jacket tube is provided with a downwardly tapering lower end.

19. The method according to claim 1, wherein the core rod comprises a core region having an outer diameter surrounded by a cladding glass layer having an outer diameter, wherein a ratio of the outer diameter of the cladding glass layer to the outer diameter of the core region ranges from 2.5 to 3.5.

20. The method according to claim 1, wherein the inner jacket tube and the outer jacket tube define therebetween an outer annular gap having a mean gap width of not more than 1 mm.
